(19) United States
(12) Patent Application Publication
(10) Pub. No.: US 2021/0377428 A1
(43) Pub. Date: Dec. 2, 2021

(54) MONITOR CAMERA

(71) Applicant: Maruzen Intec Co., Ltd., Osaka (JP)

(72) Inventor: Junichi NAKAI, Osaka (JP)

(21) Appl. No.: 17/328,018

(22) Filed: May 24, 2021

(30) Foreign Application Priority Data
May 29, 2020 (JP) 2020-094865

(51) Int. Cl. H04N 5/225; H04N 5/232; H04N 5/235

(52) U.S. Cl. CPC H04N 5/2258; H04N 5/23296; H04N 5/2353; H04N 5/23238

(57) ABSTRACT

A monitor camera 10 comprises a first camera module 1 for generating first video data D1 by photographing a first monitoring region R1, and a second camera module 2 for generating second video data D2 by photographing a second monitoring region R2 including a predetermined region of interest in the first monitoring region R1, wherein the frame rate of the second video data D2 is higher than the frame rate of the first video data D1, the resolution of the second video data D2 is lower than the resolution of the first video data D1, and the number of pixels of an image sensor used for the second camera module 2 is less than the number of pixels of an image sensor used for the first camera module 1.

### TECHNICAL FIELD

The present invention relates to a monitor camera.

### BACKGROUND ART

Image sensors have become increasingly advanced in terms of their resolution and performance, and high-resolution cameras equipped with such image sensors have been put into practical use. Demand for wide-angle and high-resolution images as well as high-quality images with a high frame rate has increased not only in the field of monitor cameras for security purposes but also in traffic monitoring cameras, and also in industrial cameras (FA cameras, machine vision, etc.). As described in PTL 1, there is a monitor camera that is capable of photographing an entire monitoring region by using a high-resolution camera, extracting a region of interest to which special attention should be given from the entire monitoring region, reading out the resulting image at a high frame rate, and displaying and recording a video of the entire monitoring region and a video of the region of interest.

There is also a monitoring device that is capable of viewing an entire monitoring region with a wide-angle camera, and viewing, in more detail, a target object in the entire monitoring region to which a user wishes to pay particular attention, by using an image photographed with a zoom camera. For example, PTL 2 discloses a monitor camera comprising a wide-angle camera for photographing an entire monitoring region, and a zoom camera for optically zooming in on and photographing an already selected region alone, wherein the monitor camera further comprises a sub-camera that is rotatable from front to back and side to side and that can photograph a blind spot of the wide-angle camera. PTL 3 discloses a multi-eye camera system in which multi-eye photographing cameras (e.g., 16 cameras) for photographing multiple partial images are used, partial images obtained from each camera are corrected and synthesized to obtain the entire image of the photographed region, and a desired region alone can be enlarged by using each camera.

### CITATION LIST

### Patent Literature

PTL 1: JP2008-219484A

PTL 2: JP2014-207548A

PTL 3: JP2019-169830A

### SUMMARY OF INVENTION

### Technical Problem

However, in the technology of PTL 1, since the entire monitoring region and the region of interest are extracted and read at a high frame rate, following the image data of the entire monitoring region. Accordingly, the capacity of image memory and the load on image processing increase, and at the same time, there is a problem that an increase in the frame rate of the region of interest reduces the frame rate of the entire monitoring region other than the region of interest. Furthermore, the resolution of the region of interest is determined by the number of pixels of the extracted image, and there is a limitation that the frame rate cannot be increased to more than the rate at which the entire monitoring region has been read.

The monitor camera of PTL 2 comprises a wide-angle camera for photographing an entire monitoring region, and a tele-view camera for zooming in on and photographing part of the monitoring region; however, PTL 2 is silent about the frame rates of images photographed by using these cameras. Accordingly, it is unclear whether a high-speed moving subject when present in the photograph range of the tele-view camera can be clearly photographed.

In the camera system of PTL 3, an entire image of a photograph region is obtained by a multi-eye photographing camera, and a desired region alone can be selected from the entire photograph region and enlarged. The entire image of the photograph region can be obtained by subjecting partial images obtained by all of the multi-eye photographing cameras to image processing using correction parameters for correcting distortion. Then, a memory for outputting the entire image to an entire image display device is required. Thus, as the number of multi-eye photographing cameras increases, the correction process becomes more complicated, and the capacities of the memory for partial images and the memory for the entire images increase. This increases the processing load on the image-processing device, which results in the problems of decreasing the processing speed and increasing power consumption and camera component costs. Although PTL 3 is silent about the frame rate of the image, an increase in the frame rate of the partial image causes a problem of reduction in the frame rate of the entire photograph region other than the partial region, as in PTL 1.

In optically zooming in on and photographing an already selected region alone, no problem occurs when a stationary or slow-moving object is photographed; however, most objects to be monitored are typically moving objects. Accordingly, in a security camera that detects the face of a person or an animal walking or running, a traffic monitor camera that recognizes the license plate of a moving car, or a factory automation (FA) camera that monitors FA equipment operating at high speed, etc., at least the region of interest (partial region) must be read out at a high frame rate to detect a high-speed moving subject. However, in order to suppress a load increase in image processing, the frame rate of the monitoring region other than the region of interest must be reduced, which makes the image other than the region of interest unclear, and reduces the monitoring effect.

An object of the present invention is to provide a monitor camera that is capable of detecting a high-speed moving subject, and that has a low image processing load.

### Solution to Problem

In order to achieve the above object, the monitor camera according to the present invention comprises a first camera module for generating first video data by photographing a first monitoring region, and a second camera module for generating second video data by photographing a second monitoring region including a predetermined region of interest in the first monitoring region, wherein the frame rate of the second video data is higher than the frame rate of the first video data; the resolution of the second video data is lower than the resolution of the first video data; and the number of pixels of an image sensor for use in the second camera module is less than the number of pixels of an image sensor for use in the first camera module.

### Advantageous Effects of Invention

According to the present invention, by setting a region of interest in a high-speed moving subject, and by reading out the region of interest at a high frame rate or enlarging the region of interest, the subject can be clearly displayed. In this case, since the first video data is not limited by the processing of the second video data, the frame rate of the first video data is not reduced, and only the frame rate of the second monitoring region is reduced. Since the second monitoring region is determined to have a higher frame rate than that of the first monitoring region, a reduction in the frame rate does not significantly affect the monitoring effect and does not increase the load on image processing. Accordingly, the present invention can detect a high-speed moving subject and reduce the load on image processing.

### BRIEF DESCRIPTION OF DRAWINGS

FIG. 1 is a front schematic view of a monitor camera according to an embodiment of the present invention.

FIG. 2 is a diagram showing a monitor camera system according to an embodiment of the present invention.

FIG. 3 is a schematic diagram showing a region photographed with a monitor camera according to an embodiment of the present invention.

FIG. 4 is a schematic diagram showing a region photographed with a monitor camera according to Example 1 of the present invention.

FIG. 5 is a schematic diagram showing a monitoring region and a region of interest of the second camera modules in the monitor camera according to Example 1 of the present invention.

FIG. 6 is a schematic diagram showing a region photographed with a monitor camera according to Example 2 of the present invention.

### DESCRIPTION OF EMBODIMENTS

Embodiments of the present invention are explained below with reference to the attached drawings. The present invention is not limited to the embodiments described below.

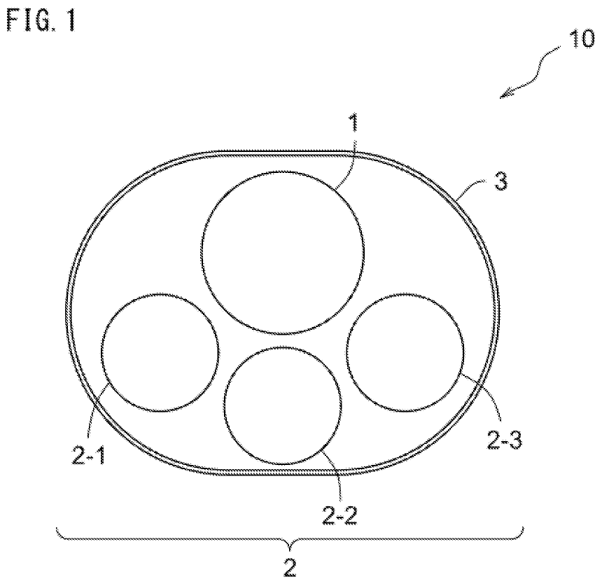

FIG. 1 is a front schematic view of a monitor camera 10 according to an embodiment of the present invention. The monitor camera 10 comprises a first camera module 1, a second camera module 2, and a frame 3. The first camera module 1 and the second camera module 2 are present in the frame 3.

One first camera module 1 is provided, and one or more second camera modules 2 are provided. In this embodiment, the second camera module 2 comprises three second camera modules 2-1 to 2-3. Since the second camera modules 2-1 to 2-3 have the same configuration as one another, they will be referred to simply as a “second camera module 2” in the following explanation unless otherwise distinguished.

Of the first camera module 1 and the second camera module 2, it is preferable that at least the second camera module 2 includes a CMOS image sensor. The CMOS image sensor is preferably a CMOS image sensor with global shutter technology. A CMOS image sensor with global shutter technology can reduce the video distortion of a high-speed moving subject.

The first camera module 1 preferably has a wide-angle lens, and the second camera module 2 preferably has an optical zoom lens. In this embodiment, the first camera module 1 is equipped with a 4K CMOS sensor, and the second camera module 2 is equipped with a 1.3-megapixel global shutter CMOS sensor.

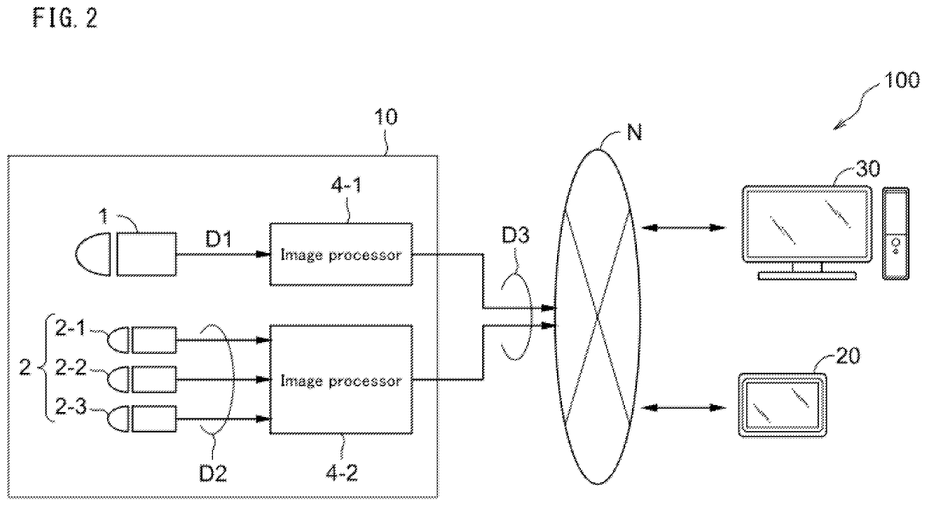

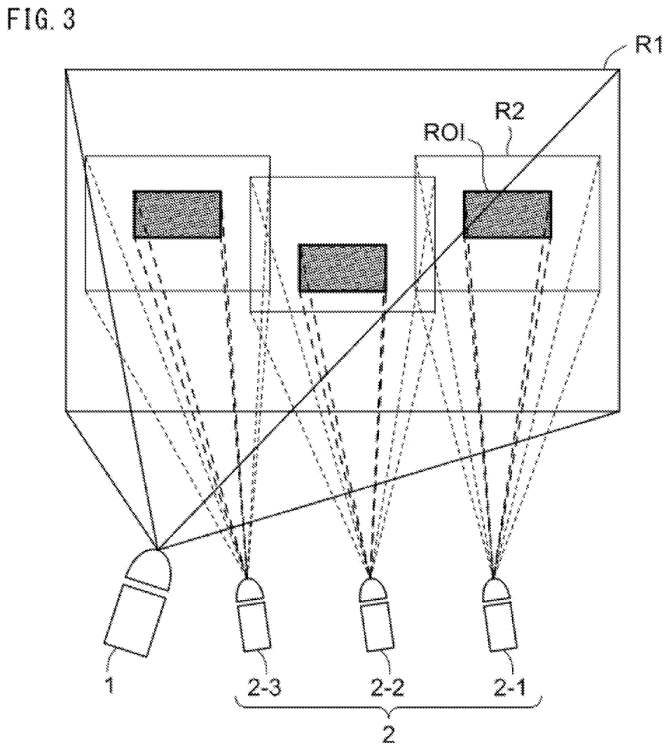

FIG. 2 is a diagram of a monitor camera system 100 according to this embodiment, and FIG. 3 is a schematic diagram showing a region to be photographed by the monitor camera 10. The monitor camera system 100 includes the monitor camera 10, a display terminal 20, and a control terminal 30. In the monitor camera 10, the first camera module 1 generates first video data D1 by photographing a first monitoring region R1, and the second camera module 2 generates second video data D2 by photographing a second monitoring region R2 including a predetermined region of interest (ROI) in the first monitoring region R1.

The first monitoring region R1 includes the entire region of a subject to be monitored, and the first camera module 1 constantly photographs the first monitoring region R1 with high resolution (e.g., 4K resolution). On the other hand, the second monitoring region R2 is smaller than the first monitoring region R1, and the second camera module 2 photographs the second monitoring region R2 with a resolution lower than that of the first camera module 1. In this embodiment, the entire second monitoring region R2 fits in the first monitoring region R1; however, the second monitoring region R2 may partially extend beyond the first monitoring region R1 as long as at least the region of interest ROI is in the first monitoring region R1. The region of interest ROI may correspond to the second monitoring region R2, or one second monitoring region R2 may include multiple regions of interest (ROIs). Although the first camera module 1 and the second camera modules 2-1 to 2-3 are described separately for the sake of convenience, they are actually present in the same frame.

As shown in FIG. 2, the first video data D1 and the second video data D2 are respectively subjected to compression and ROI processing with an image processor 4-1 and an image processor 4-2, and converted to video data D3. The compression format is not particularly limited, and examples include MPEG and H.264/H.265. The video data D3 is transmitted to the control terminal 20 and/or the display terminal 30 via network line N. Alternatively, the video data D3 may be transmitted by wired communication such as USB 3.0. The display terminal 20 can display images photographed by the first and second camera modules 1 and 2 based on the video data D3. The control terminal 30 can analyze and store the video data D3, in addition to displaying the video data D3.

The region of interest (ROI) in the second monitoring region R2 is set to a position where a high-speed moving subject passes or is present. As described below, for example, when the first monitoring region R1 is an entire multi-lane highway, the region of interest ROI is set to a position where the license plate of each vehicle passes. By reading out the region of interest (ROI) at a high frame rate, or enlarging the ROI, the subject can be displayed clearly.

In the technology of PTL 1, in order to clearly read the license plate of each vehicle passing at high speed, it is necessary to extract image data of the region of interest that a user wishes to read out at a high frame rate from the image data of the entire monitoring region photographed by one high resolution camera. However, in order to suppress the load increase in image processing, the frame rate of the monitoring region other than the region of interest must be reduced.

In contrast, in this embodiment, the frame rate of the second video data D2 generated by the second camera module 2 is larger than the frame rate of the first video data D1 generated by the first camera module 1. Since the first video data D1 is not limited by the processing of the second video data D2, the frame rate of the first video data D1 is not reduced; and when the region of interest (ROI) is read out at a high frame rate with an ROI function, only the frame rate of the second monitoring region R2 is reduced. Since the second monitoring region R2 is determined to have a higher frame rate than that of the first monitoring region R1, a reduction in the frame rate does not significantly affect the monitoring effect and does not increase the load on image processing. Accordingly, the present invention can detect a high-speed moving subject and reduce the load on image processing.

In the monitor camera 10 according to this embodiment, the first and second camera modules 1 and 2 are present in the same frame 3. This facilitates a reduction in size and weight of the monitor camera 10, thus not taking up the space for providing the monitor camera 10, and not requiring the use of a large and expensive optical lens as used by typical monitor cameras. Accordingly, the size and cost of the monitor camera system 100 can be reduced.

The embodiment of the present invention is explained above; however, the present invention is not limited to this embodiment, and various changes are possible as long as they do not deviate from the gist of the present invention.

### EXAMPLES

Examples of the present invention are detailed below; however, the present invention is not limited to these Examples.

### Example 1

The monitor camera according to Example 1 is equipped with a global shutter CMOS sensor (IMX250, produced by Sony Marketing Inc.) as the first camera module, and three global shutter CMOS sensors (PYTHON1300, produced by ON Semiconductor) as the second camera modules. The frame rate of a video photographed by the first camera module is 75 fps, and the number of pixels is 5.1 million. The frame rate of a video photographed by each second camera module is 168 fps (USB 3.0), and the number of pixels is 1.3 million. The first camera module includes a wide-angle lens, and each second camera module includes a 3x optical zoom lens.

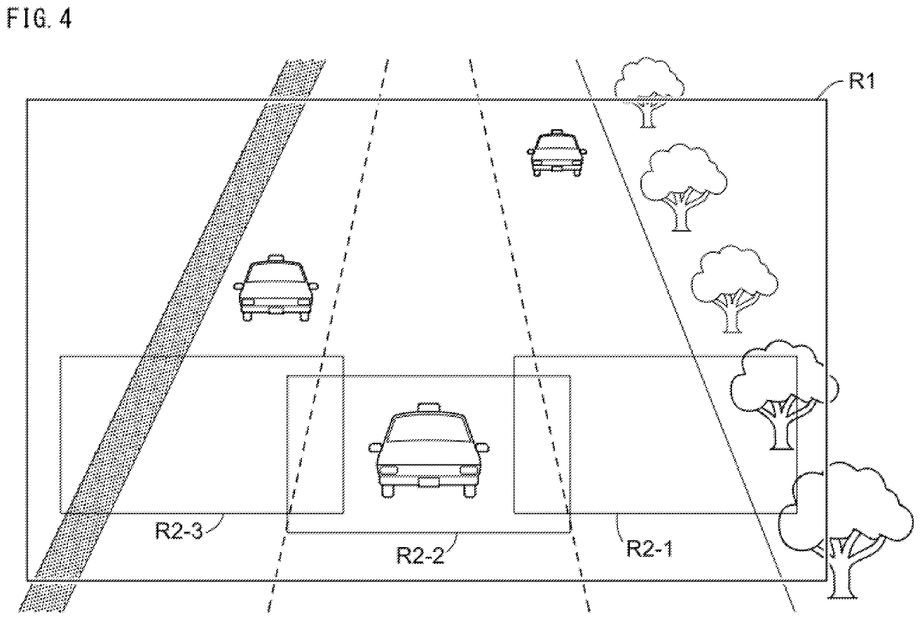

FIG. 4 is a schematic diagram showing a region photographed by the monitor camera according to Example 1. The first monitoring region R1 photographed by the first camera module covers the entire width of three lanes of a highway. The second monitoring regions R2-1, R2-2, and R2-3 photographed by the three second camera modules respectively cover the lane on the right (first lane), the middle lane (second lane), and the lane on the left (passing lane), and it is possible to photograph passing vehicles from the approximate front. In this case, the second monitoring regions R2-1, R2-2, and R2-3 may partially overlap one another. By placing the three second camera modules in this manner, the three lanes of a highway are fully covered.

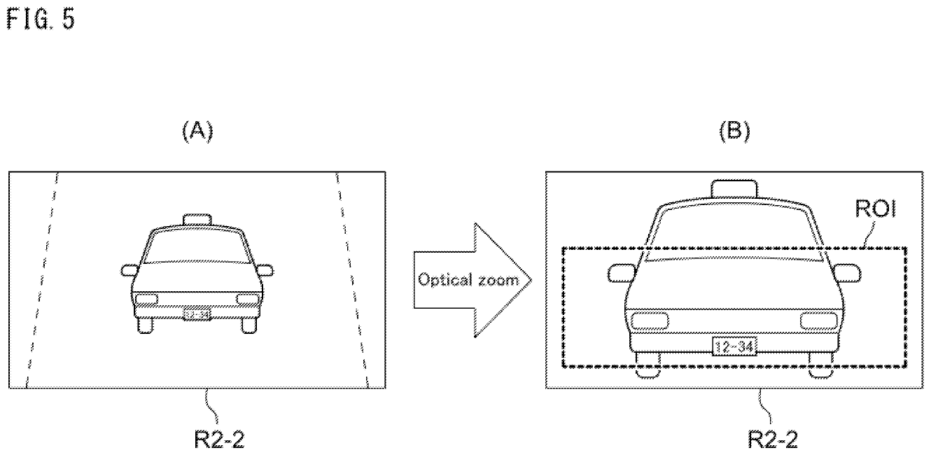

FIG. 5(A) is an image of the second monitoring region R2-2. The image can be enlarged by using an optical zoom function, as shown in FIG. 5(B). In the second monitoring region R2-2, the front of a vehicle traveling at high speed, especially the portion where the license plate passes, is determined to be the region of interest (ROI). In this Example, by setting the number of pixels in the region of interest (ROI) to about 380000, the frame rate of the region of interest (ROI) can be set to about 300 fps. This enables obtaining clear information about the license plate from the obtained image. By performing this process on the three second camera modules, information about the license plates of passing vehicles in all lanes can be clearly obtained.

### Example 2

The monitor camera according to Example 2 is equipped with a global shutter CMOS sensor (PYTHON2000 produced by ON Semiconductor) as the first camera module, and global shutter CMOS sensors (IMX287, produced by Sony Marketing Inc.) as the second camera modules. The frame rate of a video photographed by the first camera module is 130 fps, and the number of pixels is 2.3 million. The frame rate of a video photographed by each second camera module is 524 fps (8 bits), and the number of pixels is 380000. The first camera module includes a wide-angle lens, and each second camera module includes a 5x optical zoom lens.

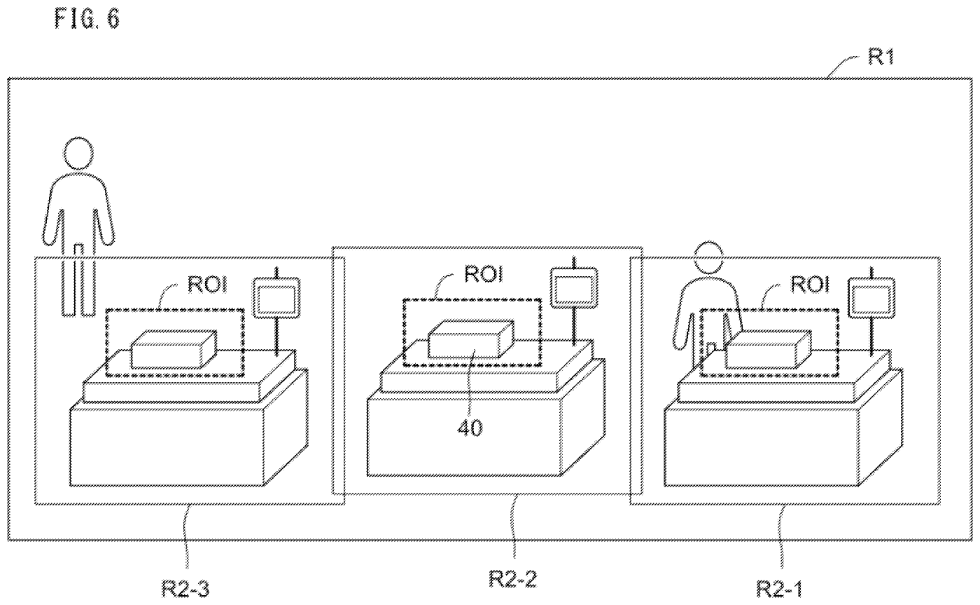

FIG. 6 is a schematic diagram showing a region photographed by the monitor camera according to Example 2. The first monitoring region R1 photographed by the first camera module covers a region including three high-speed automatic assembly equipment pieces installed in the factory and including their surroundings. The second monitoring regions R2-1, R2-2, and R2-3 photographed by the three second camera modules cover each of the high-speed automatic assembly equipment pieces. Each of the second monitoring regions R2-1, R2-2, R2-3 is set so that the region of interest ROI includes a high-speed moving part 40.

By setting the number of pixels in the region of interest (ROI) to about 300000, the frame rate of the region of interest (ROI) can be set to about 600 fps. Further, the frame rate of the region of interest (ROI) can be set to about 1000 fps by setting the number of pixels in the region of interest (ROI) to about 110000. The image of the region of interest (ROI) can be enlarged with an optical zoom.

### Additional Remarks

In the Examples described above, for the sake of explanation, the region of interest is set after the second monitoring region photographed by each second camera module is enlarged with an optical zoom; however, it is also possible to first set the region of interest in the second monitoring region, confirm the video of the second monitoring region, and then enlarge the region of interest with an optical zoom. Alternatively, the region of interest may be set after the second monitoring region is limited by using an electronic zoom function (limiting the number of read pixels.) Moreover, it is also possible to use the second monitoring region to be photographed by each second camera module as the region of interest, without separately setting the region of interest.

### Explanation of Symbols

1: First camera module
2: Second camera module
2-1: Second camera module
2-2: Second camera module
2-3: Second camera module
3: Frame
10: Monitor camera
D1: First video data
D2: Second video data
R1: First monitoring region
R2: Second monitoring region
R2-1: Second monitoring region
R2-2: Second monitoring region
R2-3: Second monitoring region
ROI: Region of interest

1. A monitor camera comprising a first camera module for generating first video data by photographing a first monitoring region, and a second camera module for generating second video data by photographing a second monitoring region including a predetermined region of interest in the first monitoring region, wherein
the frame rate of the second video data is higher than the frame rate of the first video data,
the resolution of the second video data is lower than the resolution of the first video data, and
the number of pixels of an image sensor used for the second camera module is less than the number of pixels of an image sensor used for the first camera module.

2. The monitor camera according to claim 1, wherein the first camera module and the second camera module are present in the same frame.

3. The monitor camera according to claim 1, wherein the second camera module is equipped with a CMOS image sensor.

4. The monitor camera according to claim 3, wherein the CMOS image sensor is a CMOS image sensor with global shutter technology.

5. The monitor camera according to claim 1, wherein the first camera module includes a wide-angle lens.

6. The monitor camera according to claim 1, wherein the second camera module includes an optical zoom lens.

7. The monitor camera according to claim 1, wherein the monitor camera comprises two or more second camera modules.
